(19) United States
(12) Patent Application Publication
(10) Pub. No.: US 2010/0018168 A1
(43) Pub. Date: Jan. 28, 2010

(54) CONTAINER HOLDER WITH A ROTATION-BLOCKING ELEMENT

(75) Inventor: Johannes Franciscus Bruijns, Uitgeest (NL)

Correspondence Address: HOFFMANN & BARON, LLP, 6900 JERICHO TURNPIKE, SYOSSET, NY, 11791, US

(73) Assignee: STORK FOOD & DAIRY SYSTEMS B.V., Amsterdam (NL)

(21) Appl. No.: 12/521,009

(22) PCT Filed: Jan. 2, 2008
(86) PCT No.: PCT/NL08/00001

§ 371 Date: Jul. 1, 2009

(30) Foreign Application Priority Data
Jan. 5, 2007 (NL) 1033174

(51) Int. Cl. B67B 3/20; B67C 3/00

(52) U.S. Cl. 53/490; 141/165; 53/300; 53/317

(57) ABSTRACT

The container holder (5) is intended for transporting at least one container (7) with a neck flange (72), the neck flange having a top surface (74), a bottom surface (73) and a lateral surface (75). In particular, the container is a bottle with a neck flange, the bottle being made of PE, PET or HDPE material. The container holder according to the invention is furthermore provided with a rotation-blocking element (10), which is movable to a blocking position. Characteristic of the invention is the fact that in the blocking position the rotation-blocking element is arranged to engage upon the neck flange of the container, in such a way that the rotation of the container relative to the container holder is blocked.

### CROSS-REFERENCE TO RELATED APPLICATIONS

This application is the National Stage of International Application No. PCT/NL2008/000001, filed Jan. 2, 2008, which claims the benefit of Netherlands Application No. 1033174, filed Jan. 5, 2007, the contents of which is incorporated by reference herein.

### FIELD OF THE INVENTION

The present invention relates to a container holder for transporting at least one container with a neck flange, the neck flange having a top surface, a bottom surface and a lateral surface, the container holder furthermore being provided with a rotation-blocking element for blocking the rotation of the container relative to the container holder, and the rotation-blocking element being movable to a blocking position.

### BACKGROUND OF THE INVENTION

A rotation-blocking element for such a container holder in the form of a bottle carrier is disclosed in US 2004/0206047 A1. The rotation-blocking element has a mounting plate with an arcuate recess. The arcuate recess provides a supporting surface which can support a bottle at the position of the bottom surface of a neck flange. Wedge-shaped elements are provided on the supporting surface, which wedge-shaped elements engage upon a bottom surface of the neck flange when a bottle is placed in the bottle carrier.

Through the weight of a filled bottle and the force on the bottle when a screw cap is being fitted, the bottle is pressed down on the wedge-shaped elements in the bottle carrier. The wedge-shaped elements penetrate into the neck flange and in doing so block the rotation of the bottle.

A disadvantage of the known bottle carrier with rotation-blocking elements is that the reliability of the rotation blocking is dependent upon the weight of the bottle or the pressure force on the bottle being pressed down on the wedge-shaped elements. In particular, in the case of bottles which are not so strong, such as HDPE bottles, where the pressure force has to remain limited in order to prevent accidental deformation of the bottle, the reliability of the rotation blocking leaves something to be desired.

Another disadvantage of the known rotation blocking is that the neck flange of the bottle becomes too damaged by the engagement upon them of the wedge-shaped elements. Particularly if the neck flange is made of transparent material, the damage to various parts on the bottom surface of the neck flange is clearly visible.

The object of the present invention is to overcome the above-mentioned disadvantages at least partially, or at least to offer a practicable alternative. In particular, the object of the invention is to provide a reliable blocking of the rotation of a container relative to a container holder.

### SUMMARY OF THE INVENTION

This object is achieved by a container holder according to the present invention. The container holder is intended for transporting at least one container with a neck flange, the neck flange having a top surface, a bottom surface and a lateral surface. In particular, the container is a bottle with a neck flange, the bottle being made of PE, PET or HDPE material. The container holder according to the invention is furthermore provided with a rotation-blocking element which is movable to a blocking position.

Characteristic of the invention is the fact that in the blocking position the rotation-blocking element is arranged to engage upon the neck flange of the container, in such a way that the rotation of the container relative to the container holder is blocked.

The rigidity of the neck flange in the radial direction is such that the neck flange retains its shape sufficiently even with the great forces that can be delivered by the rotation-blocking element. According to the invention, rotation blocking which can withstand a moment of at least 5 Nm around the axial axis of the neck flange can be obtained.

The reliability of the rotation blocking is not dependent upon the weight or the pressure force upon the container, but is dependent upon the force with which the rotation-blocking element is moved to the blocking position. The necessary force can be determined and applied accurately. This increases the reliability and reproducibility of the rotation blocking.

By means of the container holder with the rotation-blocking element according to the invention, the rotation of the container relative to the container holder is advantageously more reliable under many different conditions. The conditions can change through, for example, heating or wear of parts of the container holder without this adversely affecting the reliability of the rotation blocking.

The rotation blocking according to the invention can be obtained on the basis of a friction force between the rotation-blocking element and the lateral surface of the neck flange, but it is preferable for the rotation-blocking element to penetrate into the lateral surface of the neck flange.

In various conditions, and in particular during the filling of containers in damp conditions, it is advantageous to use a rotation-blocking element which penetrates into the lateral surface of the neck flange. Through the penetration of the rotation-blocking element, the reliability and reproducibility of the rotation blocking is guaranteed in changing conditions. There is little or no adverse effect on the reproducibility if the container becomes wet or heats up, or if it is subject to wear.

The fact that the neck flange of a container is penetrated through the lateral surface by the rotation-blocking element according to the invention has the advantage that the penetration can be deeper than that occurring when the neck flange is penetrated through the bottom surface or top surface. In general, the neck flange does not have a greater projecting diameter in the radial direction than its thickness in the axial direction. The thickness of the neck flange is not a limiting factor for the penetration through the lateral surface.

The rotation-blocking element is preferably a rotation-blocking knife. During the movement to the blocking position, the rotation-blocking knife will penetrate with a cutting action into the lateral surface of the neck flange of the container. This produces a small notch in the lateral surface of the neck flange.

The rotation-blocking knife preferably has a knife edge with an apex angle between a minimum of 15° and a maximum of 900, but preferably 30°. This advantageously means that the size of the notch remains limited. The notch on the lateral surface is a permanent deformation, but is visually less conspicuous than a permanent deformation in the bottom surface or in the top surface of the neck flange. The rotation-blocking knife therefore ensures that there is hardly any visible damage to the neck flange. Furthermore, the notch has been produced by incision of the rotation-blocking knife, which produces less visible damage than, for example, when a knurl is pressed into the neck flange. Furthermore, a notch leaves the neck flange intact as regards rigidity and strength.

The container holder preferably has a supporting surface for supporting the bottom surface of the neck flange of a container, and the rotation-blocking knife preferably has a knife edge which is in a position substantially perpendicular to the supporting surface. It is advantageously hereby ensured that in the blocking position of the rotation-blocking knife the knife edge engages upon the lateral surface of the neck flange.

In a preferred embodiment the knife edge of the rotation-blocking knife is situated at an acute angle of a minimum of 20° and a maximum of 85° relative to the supporting surface of the container holder. Through the acute angle, during movement towards the blocking position the knife edge will engage upon both the lateral surface and the top surface of the neck flange of the container. Through the acute angle, which is preferably 25°, an improved incisive action of the rotation-blocking element into the neck flange is obtained. The improved incisive action means that the risk of inadmissible damage to the neck flange is further reduced.

Further preferred embodiments are set out in the subclaims.

The invention also relates to a screw cap station, a filling and closing device, a rotation-blocking knife and a method for fixing a screw cap on a container with a neck flange according to embodiments described hereinafter.

### BRIEF DESCRIPTION OF THE DRAWINGS

The invention will be explained in greater detail with reference to the appended drawings, which give a practical embodiment of the invention, but must not be regarded in a limiting sense, in which drawings:

FIG. 1 is a diagrammatic view in section of a filling and closing device;

FIG. 2 is an enlarged partial view of the screw cap station in FIG. 1;

FIG. 3 is a front view of one of the container holders in FIG. 1;

FIG. 4 is a variant of the screw cap station;

FIG. 5 is a top view of a rotation-blocking element according to the invention;

FIG. 6 is a side view of the rotation-blocking element according to FIG. 5; and

FIG. 7 shows a diagrammatic front and top view of a container with a neck flange, in which the rotation-blocking element of FIG. 5 is shown in cross section and in engagement with the neck flange.

### DETAILED DESCRIPTION OF PREFERRED EMBODIMENTS

In order to make the figures clearer, corresponding parts in the various figures are indicated by the same reference numerals in each case.

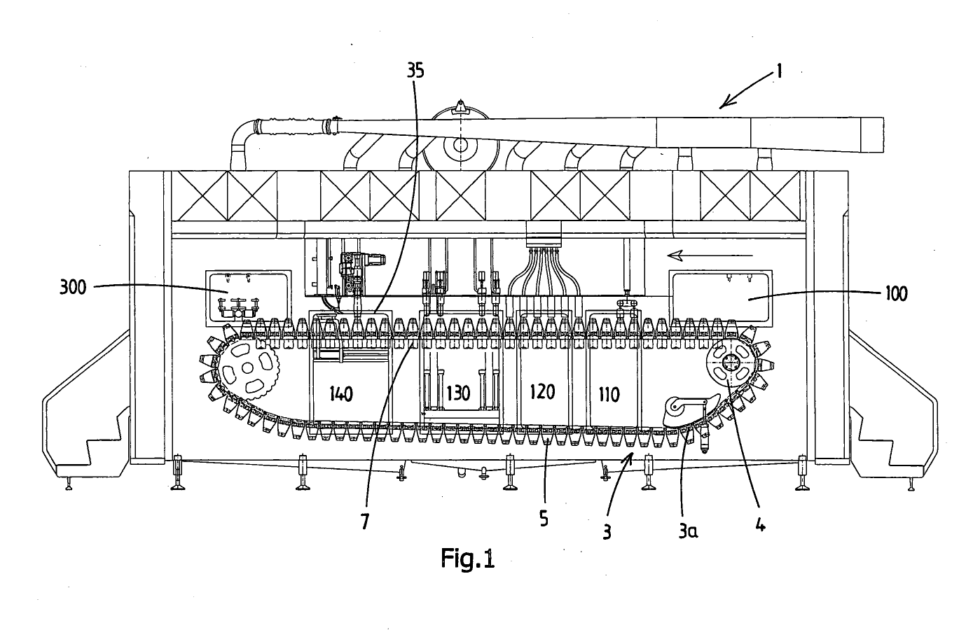

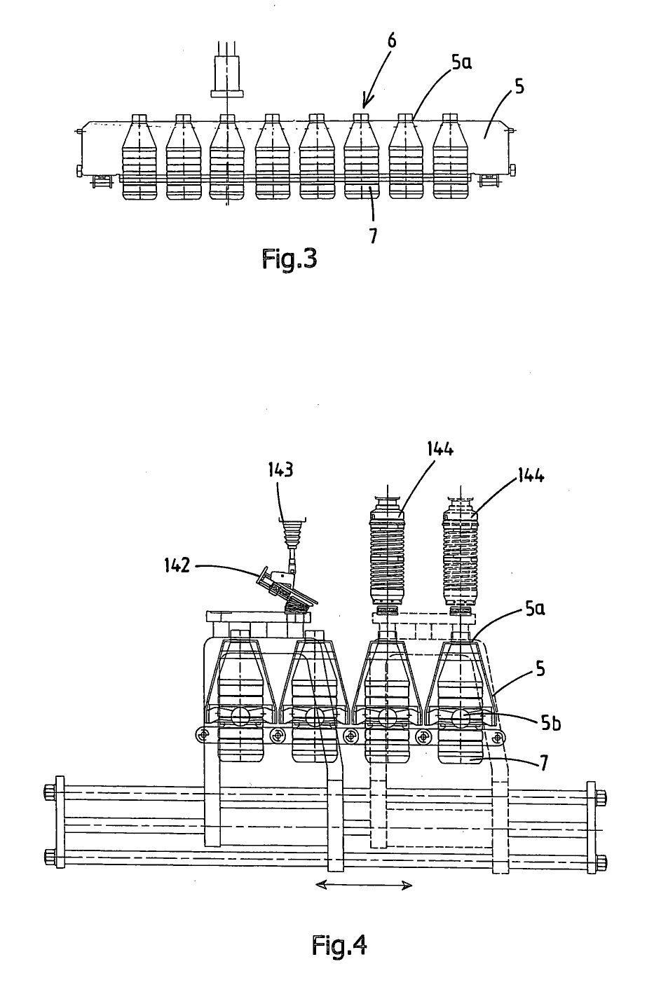

In FIG. 1 a filling and closing device is indicated in its entirety by the reference numeral 1. The device 1 comprises a conveyor system 3 with an endless conveyor chain 3a, which is guided over sprocket wheels 4, by means of which the conveyor chain 3a can be driven. A number of container holders 5 are mounted on the conveyor chain 3a. Each container holder 5 comprises at least four adjacent container accommodation positions 6 (see FIG. 3).

The containers 7 are placed in the container holders 5 at a container infeed 100. The filling and closing device 1 is made up of a number of sections, which are all provided along the conveyor system 3. In succession, a section with a decontamination station 110, a drying station 120, a filling station 130 and a screw cap station 140 are provided. The stations are preferably in the form of exchangeable modules, and are disposed in line along an upper, substantially straight track section of the conveyor system 3. The stations extend here in a direction running transversely to the direction of conveyance along the number of container accommodation positions 6 and are, for example, centrally fed with decontamination fluid, sterile screw caps and filling medium respectively. In one variant, one or more of the stations can also be provided along the lower track section or the bend sections of the conveyor system 3.

As can be seen in FIG. 1, in the decontamination station 110 the inside and at least the top of the outside of the containers 7 are decontaminated, for example with hot hydrogen peroxide vapour. In the drying station 120 the containers 7 are dried, for example with hot sterile air. In the filling station 130 the containers 7 are filled by means of filling valves and filling orifices with medium, in particular liquid medium, more particularly liquid food product. The medium is supplied here to the filling orifices from a product tank.

The device 1 comprises a so-called defined aseptic zone, so that the various operations on the containers can be performed under aseptic conditions. For this purpose, a housing 35 which at least partially encloses the conveyor system 3 is provided. Gas supply means for supplying conditioned gases, in particular hot hydrogen peroxide vapour, open into the housing 35. A slight excess pressure is maintained inside the housing 35. The excess pressure prevents dirty outside air from penetrating into the aseptic zone. In addition, a controlled downward flow of the gases preferably occurs at the filling apertures of the containers 7. The downward flow ensures that any contamination is discharged directly downwards. This ensures that recontamination of the containers 7 does not occur. In particular, the gas volume in the aseptic zone inside the housing 35 is refreshed here at least twice a second.

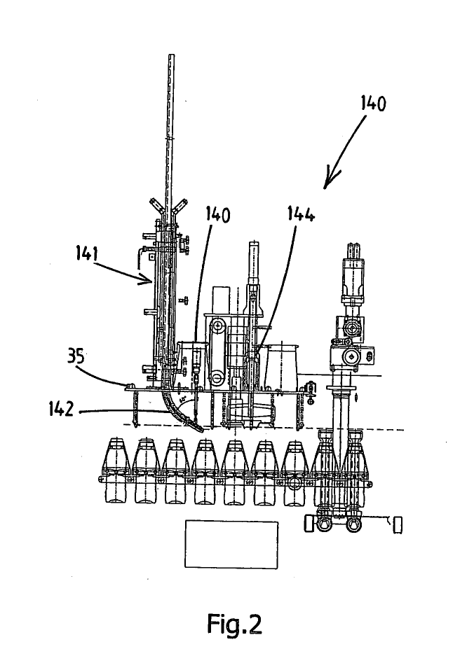

As FIG. 2 shows in greater detail, the aseptic zone is preferably kept as small as possible by placing the drives of the stations outside the housing 35 as far as possible. In particular, the sterilization unit 141 of the aseptic cap feed and a part of the chute 142 are placed outside the housing 35, and also the pneumatic system for controlling the metering device 143, and drives for the screw-on element 144. In this way it is ensured that contamination and faults are kept to a minimum, and the reliability can be guaranteed.

After the decontaminated and filled containers 7 have been provided with a screw cap, they can be removed from the device 1 by means of a container discharge unit 300. The empty container holders 5 are then taken back again along the bottom by the conveyor chain 3 to the container inlet 100, after which the process of in line decontamination, filling and providing with a screw cap can be repeated again for that particular container holder 5.

The device is suitable for many types of containers, but is particularly suitable for filling a plastic bottle provided with a screw cap, in particular a bottle made of PET, PE and PP. Glass bottles provided with a screw cap closure or carton packs can also be handled. Thanks to the aseptic filling that can be achieved, the device is furthermore particularly suitable for filling containers with perishable products, in particular foods.

FIG. 2 shows an enlarged view of the screw cap station 140 in FIG. 1. The screw cap station 140 comprises a sterilization unit 141, by way of which screw caps arrive in a sort of chute 142. A metering device 143, in this case in the form of a pneumatically controlled tumbler, is provided on the end of the chute 142. The tumbler allows through one screw cap per movement cycle, which screw cap then slides by means of gravity into a recess of a cap conveyor system. The cap conveyor system conveys the screw caps underneath screw-on elements 144. The screw-on element 144 comprises an integral screw cap clamp on its bottom end. After the cap conveyor system has been moved back to its initial position, the screw-on operation can begin. For this purpose, the screw-on element 144 is arranged to perform a combined movement, consisting of a rotating movement and a vertical down going movement. At the end of the screw-on movement the screw-on elements 144 are returned to their initial position.

As indicated above, the screw cap station 140 extends in the transverse direction over the number of adjacent container accommodation positions 6. The screw cap station 140 here preferably for each container accommodation position 6 comprises its own screw-on element 144 which can be driven individually.

The screw cap station 140 is arranged to screw caps on the containers in a cycle time of less than 5 seconds. This means that, for example in the situation shown with eight adjacent container accommodation positions 6, over 12,000 containers per hour can be filled and provided with a screw cap with the device according to the invention.

Depending on the configuration of the device 1, the screw cap station 140 can also be designed with a number of screw-on elements 144 placed one after the other in the direction of conveyance. FIG. 4 shows, for example, an embodiment with two rows of screw-on elements 144 placed one after the other in the direction of conveyance.

FIG. 3 shows the container holder 5 in greater detail, and illustrates an embodiment with eight container accommodation positions 6 with containers 7 accommodated in them. As FIG. 4 shows in a side view, the container holder 5 is designed here with two flap-open parts, which can swing about an axis 5b. In a closed state the containers 7 are held in place by a neck flange 72 between the two flap-open parts, so-called neck transport. The neck flange is supported here by a supporting surface 5a of the container holder.

During the placing and tightening of screw caps, rotation of the container 7 relative to the container holder 5 is blocked by means of a rotation-blocking element. This ensures that the containers 7 do not turn along with the screw caps. In the case of a container holder 5 with a number of container accommodation positions 6 it has been found that in particular the containers 7 in the middle have the tendency to turn along with the screw caps. Each individual container here is provided with a rotation-blocking element.

The rotation-blocking element is preferably a rotation-blocking knife having a knife edge which is in a position substantially perpendicular to the supporting surface 5a. This means that during the movement towards the neck flange the rotation-blocking knife will engage upon the lateral surface of the neck flange. In the container holders shown in FIG. 4 the rotation-blocking elements move along with the flap-open parts of the container holder. In this way rotation blocking is provided at the same time as the containers are being accommodated in the container holder.

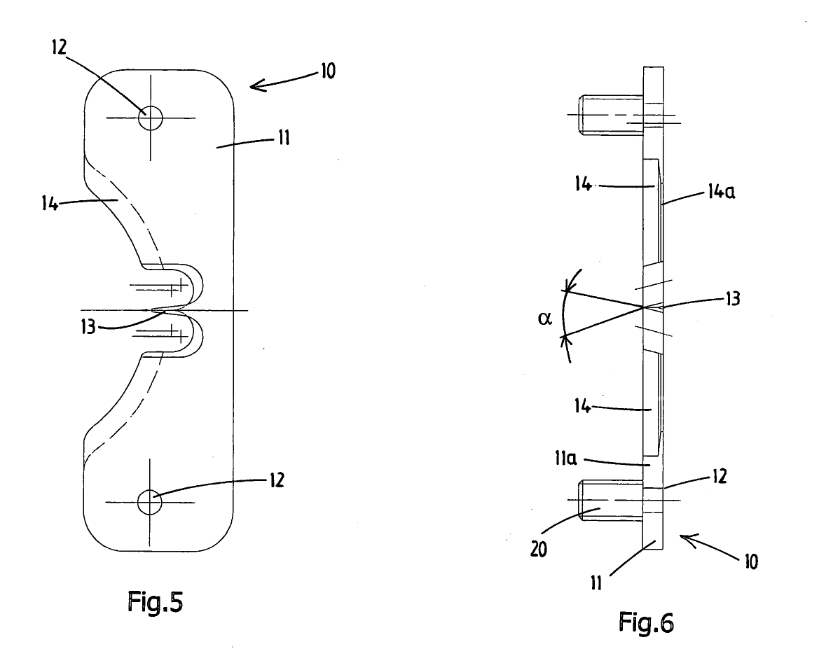

FIG. 5 shows a rotation-blocking element, here a rotation-blocking knife 10 which comprises a mounting plate 11. The mounting plate is rectangular in shape and has near the ends a hole 12 for fixing a dowel pin. An arcuate recess 14 is provided centrally in the mounting plate 11. A knife edge 13 is present in the arcuate recess 14. The knife edge 13 here is formed together with the mounting plate in one piece.

FIG. 6 shows a side view of the rotation-blocking knife 10 of FIG. 5. The mounting plate 11 has a mounting surface 11a for mounting the rotation-blocking knife on the container holder. For correct positioning of the rotation-blocking knife 10 on the container holder, the mounting plate 11 is provided with two dowel pins 20, which are fitted in the holes 12. The knife edge 13 is situated in a centrally located part of the mounting plate 11. The knife edge 13 here has an apex angle α lying between a minimum of 15° and a maximum of 90°, but angle α is preferably 30°.

As FIG. 6 shows, the knife edge 13 in the mounting plate 11 is obtained by two slanting slits in the mounting plate 11. The apex angle α is obtained by cutting the slits in the mounting plate at an angle of, for example, 30° relative to each other. The rotation-blocking knife 10 is thus surprisingly simple to produce and still has the necessary functionality.

The recess 14 is shown in the side view of the rotation-blocking knife 10 shown in FIG. 6. A recess 14 is provided in the mounting plate 11 as a centring element for positioning the neck flange of a container. The recess 14 here has a circular wall part with a diameter which corresponds to the diameter of a lateral surface of a neck flange.

Furthermore, the recess 14 comprises a vertical wall part 14a Said vertical wall part 14a is situated above a top surface of a neck flange when the rotation-blocking knife is taken into the blocking position. As a result of this, the neck flange of the container is advantageously confined, consequently retaining its shape, inside the recess 14 of the mounting plate 11.

At least two mounting plates are advantageously used on a container holder to obtain complete confinement of the container. For this purpose, it is not necessary for both mounting plates to be provided with a knife edge 13. By confining the neck flange between the two mounting plates in the recesses 14 with the vertical wall parts 14a, it is ensured that the neck flange does not spring up. The reliability of the rotation blocking is further improved in this way.

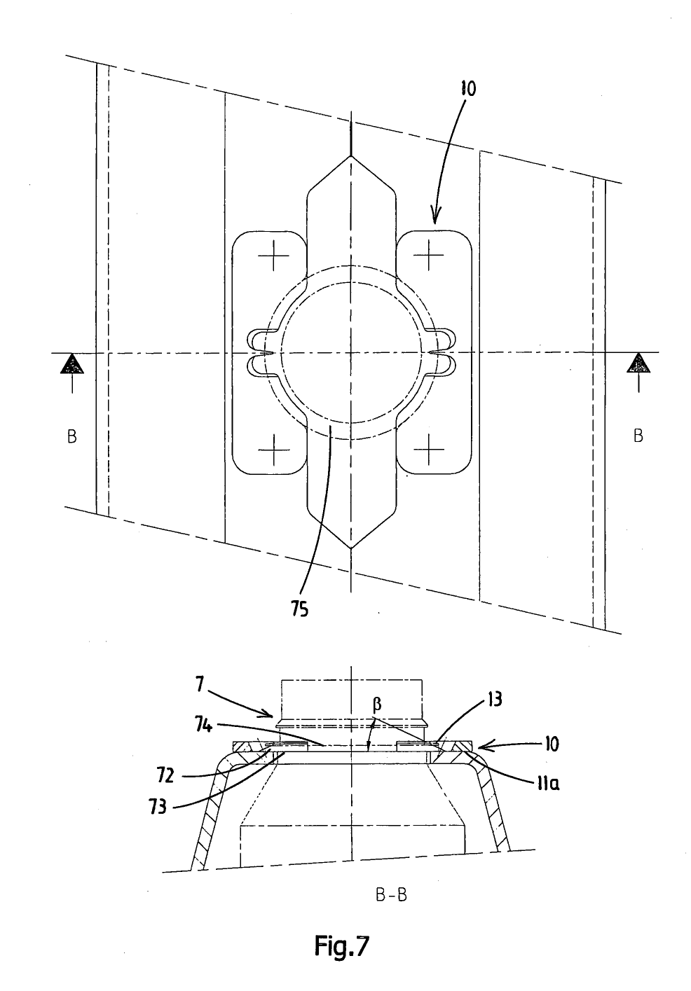

FIG. 7 shows in a diagrammatic view a part of a container, here a bottle 7 with a neck flange 72. The neck flange has a top surface 74, a bottom surface 73 and a lateral surface 75. The neck flange 72 is situated at the position of the neck of the bottle 7. The bottle 7 is situated in a bottle carrier (not shown), which is provided with a rotation-blocking knife 10, as shown earlier in FIG. 5 and FIG. 6. The rotation-blocking knife 10 is shown in cross section along the line A-A of FIG. 5. The rotation-blocking knife 10 is in the blocking position here. The knife edge 13 has cut into the neck flange 72. The knife edge 13 has penetrated into the neck flange 72. Since the knife edge 13 here forms an acute angle β of approximately 25° with the mounting surface 11a, the knife edge 13 has penetrated into both the lateral surface 75 and the top surface 74.

Many variants are possible in addition to the embodiments shown in the figures. In one variant of the rotation-blocking knife shown, the knife can be fitted as a separate part on the mounting plate. In a further variant the knife can also be fitted directly on the container holder without making use of a mounting plate.

It is clear from the figures that the rotation-blocking knife is rigidly connected to the container holder by means of dowel pins in a mounting plate. In one variant the rotation-blocking knife can also be set up so that it moves relative to the container holder, so that the clamping of the container does not have to be in synchronism with the blocking of the rotation of the container relative to the container holder.

As an alternative to the knife edge of the rotation-blocking knife shown, a knurl, a projection with a small radius or a pin-shaped rotation-blocking element with a sharp point will also suffice. It is also possible in a variant to obtain rotation blocking by clamping on the lateral surface of the neck flange of the container by means of friction-increasing material.

Furthermore, in a variant of the arcuate recess shown for centring of a neck flange it is possible to use a recess in the case of which the lateral surface of the neck flange rests only against part of a wall part of a recess. Instead of a recess, dowel pins could also be used for centring the neck flange.

In this way a container holder which provides reliable blocking of the rotation of the container relative to the container holder is obtained. The reproducibility and durability of the rotation blocking is satisfactory in various conditions such as heating, damp or wear. Furthermore, the visual damage to the neck flange of the container is minimized.

1. A container holder for transporting at least one container with a neck flange, the neck flange having a bottom surface, a top surface and a lateral surface, the container holder furthermore being provided with a rotation-blocking element for blocking rotation of the container relative to the container holder, and the rotation-blocking element being movable to a blocking position, wherein in the blocking position the rotation-blocking element is arranged to engage upon the lateral surface of the neck flange (of the container, in such a way that the rotation of the container relative to the container holder is blocked.

2. The container holder according to claim 1, wherein in the blocking position the rotation-blocking element penetrates into the lateral surface of the neck flange of the container.

3. The container r holder according to claim 2, wherein the rotation-blocking element is a rotation-blocking knife.

4. The container holder according to claim 3, wherein the container holder comprises a supporting surface for supporting the bottom surface of the neck flange of a container, and the rotation-blocking knife comprises a knife edge which is in a position substantially perpendicular to the supporting surface.

5. The container holder according to claim 4, wherein the knife edge forms an acute angle relative to the supporting surface of a minimum of 20° and a maximum of 85°, in such a way that in the blocking position the knife edge engages upon the lateral surface and the top surface of the neck flange of the container.

6. The container holder according to claim 3, wherein the rotation-blocking knife has a knife edge with an apex angle between a minimum of 15° and a maximum of 90°.

7. The container holder according to claim 1, in which the rotation-blocking element furthermore comprises a centring element for centring a container, which centring element during centring of the container abuts the lateral surface of a neck flange.

8. The container holder according to claim 7, wherein the centring element is a circular wall part of a recess.

9. The container holder according to claim 1, wherein the container holder is provided with at least four container accommodation positions, each container accommodation position being provided individually with a rotation-blocking element.

10. A screw cap station for fitting a screw cap on a container with a neck flange, comprising the container holder according to claim 1.

11. A filling and closing device for filling and closing with a screw cap a container with a neck flange, comprising a container holder according to claim 1.

12. A rotation-blocking element for blocking rotation of a container relative to a container holder, the container comprising a neck flange having a top surface, a bottom surface and a lateral surface, and the rotation-blocking element being mountable on the container holder, wherein after mounting on the container holder the rotation-blocking element is arranged to engage upon the lateral surface of the neck flange in a blocking position.

13. A method for fixing a screw cap on a container with a neck flange, the neck flange having a top surface, a bottom surface and a lateral surface, comprising the following steps:
placing the container in a container holder;
blocking rotation of the container relative to the container holder by means of a rotation-blocking element;
positioning the container relative to a screw cap placing device;
placing a screw cap on the container;
tightening a screw cap on the container;
unblocking the rotation of the container relative to the container holder;
removing the container from the container holder;
wherein the rotation of the container is blocked by the rotation-blocking element engaging upon the lateral surface of the neck flange.
